(19) United States
(12) Patent Application Publication
(10) Pub. No.: US 2019/0270671 A1
(43) Pub. Date: Sep. 5, 2019

(54) ADDITIVE FOR CONSTRUCTION CHEMICAL COMPOSITIONS

(71) Applicant: BASF SE, Ludwigshafen am Rhein (DE)

(72) Inventors: Torben GAEDT, Trostberg (DE); Joachim DENGLER, Trostberg (DE); Oliver MAZANEC, Trostberg (DE); Christoph HESSE, Trostberg (DE); Sebastian SEUFERT, Trostberg (DE); Michael SCHINABECK, Trostberg (DE)

(73) Assignee: BASF SE, Ludwigshafen am Rhein (DE)

(21) Appl. No.: 16/345,404

(22) PCT Filed: Oct. 23, 2017
(86) PCT No.: PCT/EP2017/076943

§ 371 Date: Apr. 26, 2019

(30) Foreign Application Priority Data
Oct. 31, 2016 (EP) 16196609.8

(51) Int. Cl. C04B 24/26; C04B 28/04; C04B 28/06; C04B 24/04; C04B 24/12; C04B 14/04

(52) U.S. Cl. CPC C04B 24/2647; C04B 28/04; C04B 28/065; C04B 40/0608; C04B 24/124; C04B 14/043; C04B 24/045

(57) ABSTRACT

The present invention concerns an additive for construction chemical compositions, in particular mortar and cement compositions. The additive comprises at least one amide or ester of a sugar acid and at least one water-soluble comb polymer which contains, on the main chain, acid functions and side chains having ether functions. The additive is useful for retarding the hardening of a construction chemical composition.

The present invention concerns an additive for construction chemical compositions, in particular mortar and cement compositions, the construction chemical compositions containing the additive and the use of the additive.

It is known that dispersants are added to aqueous slurries or pulverulent inorganic or organic substances, such as clays, silicate powder, chalk, carbon black, crushed rock and hydraulic binders, for improving their processibility, i.e. kneadability, spreadability, sprayability, pumpability or flowability. Such admixtures are capable of preventing the formation of solid agglomerates and of dispersing the particles already present and those newly formed by hydration and in this way improving the workability. This effect is utilized in particular in a targeted manner in the preparation of building material mixtures which contain hydraulic binders, such as cement, lime, gypsum, hemihydrate or anhydrite.

In order to convert these building material mixtures based on said binders, into a ready-to-use, processible form, as a rule substantially more mixing water is required than would be necessary for the subsequent hydration or hardening process. The proportion of voids which is formed in the concrete body by the excess of water, subsequently evaporating water leads to significantly poorer mechanical strengths and resistance.

In order to reduce said excess proportion of water at a predetermined processing consistency (workability) and/or to improve the workability at a predetermined water/binder ratio, admixtures are used which are generally referred to as water-reducing agents or plasticizers. In practice copolymers obtained by radical copolymerization (also known as polycarboxylate ethers (PCE)) are used as such agents.

Copolymers of this type are prepared by free-radical copolymerization of acid monomers (for example (meth)acrylic acid) with polyether macromonomers (for example polyalkylene glycol (meth)acrylates) and are described, for example, in EP 0753 488 A2. The properties of the polycarboxylate ethers depend significantly on factors such as acid monomer content and side chain length of the polyalkylene glycol structural units. It is possible by modification of the monomer content or the side chain length to produce either water reducers (sufficient initial slump is obtained, but slump-retention is usually not so good) or slump retainers (initial slump may be not sufficient, but slump-retention over time is satisfactory).

Ternary binder systems containing Ordinary Portland Cement (OPC), calcium aluminate cement and calcium sulfate based binders are frequently used, for example in self-levelling underlayments (SLU), and are described in “Lamberet S., 2004, Durability of ternary binder systems based on Portland Cement, calcium aluminate cement and calcium sulfate, Thèse École polytechnique fédérale de Lausanne EPFL, no 3151 (2005)” and “Zurbriggen, R.; Bihler, E.; Lang, J. (2006). Mixed-binder based self-levelling flooring compounds: Critical formulations—the reason for typical damages. 16. Ibausil Weimar”.

Binary binder systems, which contain Ordinary Portland Cement (OPC) and calcium sulfate based binders are for example described in the U.S. Pat. No. 5,685,903 in applications for floor underlayments, floor and road patching materials and fiberboards. The construction materials contain from about 20 weight % to about 75 weight % calcium sulfate beta-hemihydrate, about 10 weight % to about 50 weight % of a cement, silica fume, pozzolanic aggregate and as a retarder a natural protein-based material.

U.S. Pat. No. 4,661,159 discloses cementitious floor underlayments including beta gypsum (45 to 55 weight %), alpha gypsum (20 to 30 weight %), Portland cement (about 20 weight %) and fly ash (about 5 weight %), in each case the weight percentages are given as values referring to the total dry weight of the composition. As retarder sodium citrate is disclosed. The compositions are said to be quick-setting, non-combustible, non-water-permeable and easy to work.

U.S. Pat. No. 7,338,990 B2 discloses a mixture for preparing a slurry that hydrates to form an exterior gypsum cement, comprising 30 to 70 weight % hydraulic cement, 30 to 70 weight % calcined gypsum and 0.05 to 2.5 weight % polycarboxylate dispersant, wherein the dispersant is based on oxyalkyleneglycol-alkyl ethers and unsaturated dicarboxylic acid derivatives. The mixtures allow improved production of molded articles due to the decreased expansion of the casted material and at the same time improved mechanical strength.

WO 00/23395 discloses a process for preparing a permeable aerated mortar by mixing a mortar material containing a rapidly hardening cement with a foam. The material may contain a conventional set retarder such as citric acid, gluconic acid, tartaric acid, malic acid, and salts thereof, sodium carbonate, potassium carbonate or sodium bicarbonate.

WO 00/44487 discloses compounds comprising a residue of a sugar or sugar derivative linked by an amine, amide, imide or urea group to a non-sugar substituent and their use for modifying the properties of cement and cementitious compositions such as fluidity, strength, grinding efficiency, and set retardation.

WO 01/04185 discloses cementitious formulations comprising a cement and an oligomeric dispersant which comprises a moiety derived from a polyhydroxy compound such as sugars, sugar acids, lactones of sugar acids etc.

Dry mortars of the prior art based on calciumsulfate hemihydrate, anhydrite or aluminate-containing cements often have the disadvantage that they are not satisfying in relation to flowability and development of compressive strength and final strength. Depending on the inorganic binder used a rapidly occurring gypsum formation (in case of calciumsulfate hemihydrate or anhydrite as inorganic binder) or a fast aluminate reaction (in case of aluminate-containing cement) results in a significantly reduced open time of the mortar and, hence, unacceptable processability. Consequently, retarders for the hydration of the anhydrous phases of the inorganic binder have to be added. Retarders according to prior art have the disadvantage that an improved workability of the mortar which is influenced by the dosage of the retarder, is connected with a reduced strength development within 1-2 days.

The problem underlying the invention was therefore to provide a construction chemical composition (building material formulation) which solves the problems of the prior art. In particular, the compositions should show an improved slump retention (reduced slump loss). Furthermore, the temperature dependency of the fluidity should be reduced. In addition, the composition should not impair the mechanical properties such as the compressive strength, in particular the compressive strength after 24 h, i.e. it should be at least comparable to that one achieved with conventional retarders.

This problem is solved by providing an additive for construction chemical compositions comprising at least one amide or ester of a sugar acid and at least one water-soluble comb polymer which contains, on the main chain, acid functions and side chains having ether functions. The additive is useful for retarding the hardening of a construction chemical composition.

Embodiments of the invention are as follows:

1. An additive for construction chemical compositions comprising
a) at least one amide or ester of a sugar acid and
b) at least one water-soluble comb polymer which contains, on the main chain, acid functions and side chains having ether functions.
2. The additive of embodiment 1, comprising an amide or ester of a sugar acid having formula (I):

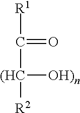

wherein
R¹ is —NR³R⁴ or —OR⁴;
R² is —CH₂OH, —COOH or —COR¹;
R³ is H, C₁-C₆-alkyl, hydroxy-C₁-C₆-alkyl or -(AO)ₓ—R⁵;
R⁴ is -(AO)ₓ—R⁵, C₁-C₆-alkyl or hydroxy-C₁-C₆-alkyl;
R⁵ is H, C₁-C₁₂-alkyl, C₁-C₁₂-alkyl substituted by —NH₂ or —X—CO—(CHOH)n-R²;

### X is —NH— or —O—;

A at each occurrence may be the same or different and is CₘH₂ₘ;
m is 2, 3, 4, 5 or 6;
n is 2, 3, 4, or 5; and
x is 1 to 100.

It is to be noted that formula (I) does not show any stereochemistry at the asymmetric carbon atoms. The formula includes all stereochemical forms, i.e. enantiomers, diastereomers and racemates.

3. The additive of embodiment 2, comprising an amide or ester of a sugar acid having formula (I), wherein
R¹ is —NR³R⁴ or —OR⁴;
R² is —CH₂OH;
R³ is H, C₁-C₆-alkyl, or hydroxy-C₁-C₆-alkyl;
R⁴ is -(AO)ₓ—R⁵ or hydroxy-C₁-C₆-alkyl;
R⁵ is H, C₁-C₁₂-alkyl or C₁-C₁₂-alkyl substituted by —NH₂;
A at each occurrence may be the same or different and is CₘH₂ₘ;
m is 2, 3, or 4;
n is 2, 3, 4, or 5; and
x is 1 to 60.
4. The additive of embodiment 2 or 3, comprising an amide or ester of a sugar acid having formula (I), wherein R¹ is —NR³R⁴.
5. The additive of embodiment 2 or 3, comprising an amide or ester of a sugar acid having formula (I), wherein R¹ is —OR⁴.
6. The additive of any one of embodiments 2 to 5, comprising an amide or ester of a sugar acid having formula (I), wherein R² is —CH₂OH or —COOH.
7. The additive of any one of embodiments 2 to 6, comprising an amide or ester of a sugar acid having formula (I), wherein R² is —CH₂OH.
8. The additive of any one of embodiments 2 to 7, comprising an amide or ester of a sugar acid having formula (I), wherein R³ is H, C₁-C₆-alkyl or hydroxy-C₁-C₆-alkyl.
9. The additive of embodiment 8, comprising an amide or ester of a sugar acid having formula (I), wherein R³ is H or hydroxy-C₁-C₆-alkyl.
10. The additive of any one of embodiments 2 to 9, comprising an amide or ester of a sugar acid having formula (I), wherein R⁴ is -(AO)ₓ—R⁵ or hydroxy-C₁-C₆-alkyl.
11. The additive of embodiment 10, comprising an amide or ester of a sugar acid having formula (I), wherein R⁴ is -(AO)ₓ—R⁵.
12. The additive of any one of embodiments 2 to 11, comprising an amide or ester of a sugar acid having formula (I), wherein x is 1 to 60.
13. The additive of any one of embodiments 2 to 12, comprising an amide or ester of a sugar acid having formula (I), wherein R⁵ is C₁-C₁₂-alkyl or C₁-C₁₂-alkyl substituted by —NH₂.
14. The additive of any one of embodiments 2 to 13, comprising an amide or ester of a sugar acid having formula (I), wherein m is 2, 3 or 4, and in particular 2 or 3.
15. The additive of any one of embodiments 2 to 13, comprising an amide or ester of a sugar acid having formula (I), wherein R⁴ is -(AO)ₓ—R⁵ and comprises at least two different groups A.
16. The additive of embodiment 15, comprising an amide or ester of a sugar acid having formula (I), wherein A is C₂H₄(EO) and C₃H₆(PO).
17. The additive of embodiment 16, wherein the molar ratio of EO:PO is in the range from 10:1 to 1:10, in particular 8:1 to 1:3.
18. The additive of any one of embodiments 2 to 17, comprising an amide or ester of a sugar acid having formula (I), wherein n is 3 or 4, in particular 4.
19. The additive of any one of embodiments 2 to 4 or 6 to 18, comprising an amide or ester of a sugar acid having formula (I), wherein R¹ is —NR³R⁴, R³ is H or C₁-C₆-alkyl, and R⁴ is -(AO)ₓ—R⁵ and R⁵ is H, C₁-C₄-alkyl or C₁-C₄-alkyl substituted by —NH₂.
20. The additive of any one of embodiments 2 to 4 or 6 to 19, comprising an amide or ester of a sugar acid having formula (I), wherein R¹ is —NR³R⁴ and R³ and R⁴ are hydroxy-C₁-C₆-alkyl.
21. The additive of any one of embodiments 2, 3, 5 to 7 or 10 to 18, comprising an amide or ester of a sugar acid having formula (I), wherein R¹ is-OR⁴, R⁴ is -(AO)ₓ—R⁵ and R⁵ is H or C₁-C₁₂-alkyl.
22. The additive of any one of the preceding claims, wherein the comb polymer comprises, as units having acid functions, at least one structural unit of the general formulae (Ia), (Ib), (Ic) and/or (Id):

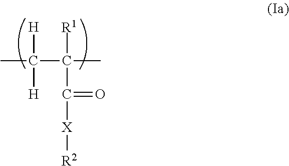

in which
R¹ is H or an unbranched or branched C₁-C₄ alkyl group, CH₂COOH or CH₂CO—X—R², preferably H or CH₃;
X is NH—(CₙH₂ₙ), O(CₙH₂ₙ) with n=1, 2, 3 or 4, where the nitrogen atom or the oxygen atom is bonded to the CO group, or is a chemical bond, preferably X is chemical bond or O(CₙH₂ₙ);
R² is OM, PO₃M₂, or O—PO₃M₂, with the proviso that X is a chemical bond if R² is OM;

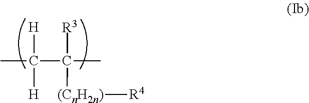

in which
R³ is H or an unbranched or branched C₁-C₄ alkyl group, preferably H or CH₃;
n is 0, 1, 2, 3 or 4, preferably 0 or 1;
R⁴ is PO₃M₂, or O—PO₃M₂;

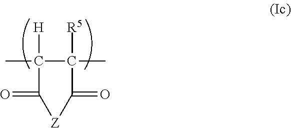

in which
R⁵ is H or an unbranched or branched C₁-C₄ alkyl group, preferably H;
Z is O or NR⁷, preferably O;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and
n is 1, 2, 3 or 4, preferably 1, 2 or 3;

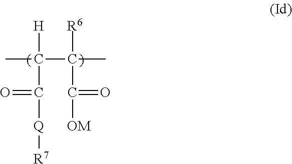

in which
R⁶ is H or an unbranched or branched C₁-C₄ alkyl group, preferably H; Q is NR⁷ or O, preferably O;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂,
n is 1, 2, 3 or 4, preferably 1, 2 or 3; and
each M independently of any other is H or a cation equivalent.
   23. The additive of any one of the preceding claims, wherein the comb polymer comprises as units having a side chain with polyether moieties at least one structural unit of the general formulae (IIa), (IIb), (IIc) and/or (IId):

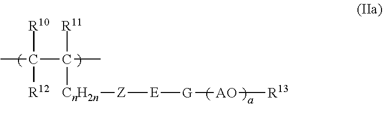

in which
R¹⁰, R¹¹ and R¹² independently of one another are H or an unbranched or branched C₁-C₄ alkyl group;
Z is O or S;
E is an unbranched or branched C₁-C₆ alkylene group, a cyclohexylene group, CH₂—C₆H₁₀, 1,2-phenylene, 1,3-phenylene or 1,4-phenylene;
G is O, NH or CO—NH; or
E and G together are a chemical bond;
A is CₓH₂ₓ with x=2, 3, 4 or 5, preferably 2 or 3, or is CH₂CH(C₆H₅);
n is 0, 1, 2, 3, 4 or 5, preferably 0, 1 or 2;
a is selected such that the number average molecular weight of the moiety -(AO)ₐ- is in the range from 1000 to 5000;
R¹³ is H, an unbranched or branched C₁-C₄ alkyl group, CO—NH₂ and/or COCH₃;

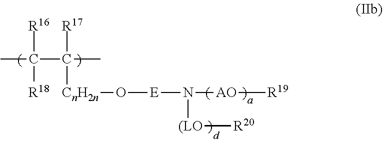

in which
R¹⁶, R¹⁷ and R¹⁸ independently of one another are H or an unbranched or branched C₁-C₄ alkyl group;
E is an unbranched or branched C₁-C₆ alkylene group, a cyclohexylene group, CH₂—C₆H₁₀, 1,2-phenylene, 1,3-phenylene, or 1,4-phenylene, or is a chemical bond;
A is CₓH₂ₓ with x=2, 3, 4 or 5, preferably 2 or 3, or is CH₂CH(C₆H₅);
n is 0, 1, 2, 3, 4 and/or 5, preferably 0, 1 or 2;
L is CₓH₂ₓ with x=2, 3, 4 or 5, preferably 2 or 3, or is CH₂—CH(C₆H₅);
a and d are selected such that the number average molecular weight of the moieties -(AO)ₐ- and -(LO)_{d}— together are in the range from 1000 to 5000;
R¹⁹ is H or an unbranched or branched C₁-C₄ alkyl group;
R²⁰ is H or an unbranched C₁-C₄ alkyl group;

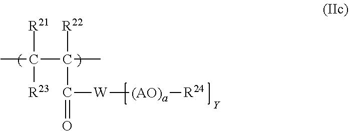

in which
R²¹, R²² and R²³ independently of one another are H or an unbranched or branched C₁-C₄ alkyl group;
W is O, NR²⁵, or is N;
Y is 1 if W═O or NR²⁵, and is 2 if W═N;
A is CₓH₂ₓ with x=2, 3, 4 or 5, preferably 2 or 3, or is CH₂CH(C₆H₅);
a is selected such that the number average molecular weight of the moiety -(AO)ₐ- or both moieties -(AO)ₐ- together are in the range from 1000 to 5000;
R²⁴ is H or an unbranched or branched C₁-C₄ alkyl group; and
R²⁵ is H or an unbranched or branched C₁-C₄ alkyl group;

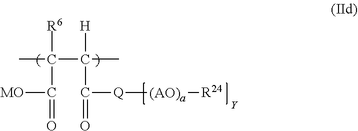

in which
R⁶ is H or an unbranched or branched C₁-C₄ alkyl group;
Q is NR¹⁰, N or O;
Y is 1 if W═O or NR¹⁰ and is 2 if W═N;
R¹⁰ is H or an unbranched or branched C₁-C₄ alkyl group; and
A is CₓH₂ₓ with x=2, 3, 4 or 5, preferably 2 or 3, or is CH₂C(C₆H₅)H;
R²⁴ is H or an unbranched or branched C₁-C₄ alkyl group;
M is H or a cation equivalent; and
a is selected such that the number average molecular weight of the moiety -(AO)ₐ- or both moieties -(AO)ₐ- together are in the range from 1000 to 5000.
   24. The additive of embodiment 23, where the comb polymer comprises a polyether side chain comprising:
   (a) at least one structural unit of the formula (IIa) in which R¹⁰ and R¹² are H, R¹¹ is H or CH₃, E and G together are a chemical bond, A is CₓH₂ₓ with x=2 and/or 3, a is as defined in embodiment 23, and R¹³ is H or an unbranched or branched C₁-C₄ alkyl group; and/or
   (b) at least one structural unit of the formula (IIb) in which R¹⁶ and R¹⁸ are H, R¹⁷ is H or CH₃, E is an unbranched or branched C₁-C₆ alkylene group, A is CₓH₂ₓ with x=2 and/or 3, L is CₓH₂ₓ with x=2 and/or 3, a and d are as defined in embodiment 23, R¹⁹ is H or an unbranched or branched C₁-C₄ alkyl group, and R²⁰ is H or an unbranched or branched C₁-C₄ alkyl group; and/or
   (c) at least one structural unit of the formula (IIc) in which R²¹ and R²³ are H, R²² is H or CH₃, A is CₓH₂ₓ with x=2 and/or 3, a is as defined in embodiment 23, and R²⁴ is H or an unbranched or branched C₁-C₄ alkyl group; and/or
   (d) at least one structural unit of the formula (IId) in which R⁶ is H, Q is O, R⁷ is (CₙH₂ₙ)—O-(AO)ₐ—R⁹, n is 2 and/or 3, A is CₓH₂ₓ with x=2 and/or 3, a is as defined in embodiment 23 and R⁹ is H or an unbranched or branched C₁-C₄ alkyl group.
   25. The additive of any of embodiments 23 or 24, where the comb polymer comprises at least one structural unit of the formula (IIa) and/or (IIc).
   26. The additive of any of embodiments 22 to 25, where the comb polymer comprises structural units of the formulae (I) and (II).
   27. The additive of any of embodiments 22 to 26, where the comb polymer comprises structural units of the formulae (Ia) and (IIa).
   28. The additive of any of embodiments 22 to 26, where the comb polymer comprises structural units of the formulae (Ia) and (IIc).
   29. The additive of any of embodiments 22 to 26, where the comb polymer comprises structural units of the formulae (Ic) and (IIa).
   30. The additive of any of embodiments 22 to 27, where the comb polymer comprises structural units of the formulae (Ia), (Ic) and (IIa).
   31. The additive of any of embodiments 28 to 33, where the comb polymer comprises (i) anionic or anionogenic structural units derived from acrylic acid, methacrylic acid, maleic acid, hydroxyethyl acrylate phosphoric acid ester, and/or hydroxyethyl methacrylate phosphoric acid ester, hydroxyethyl acrylate phosphoric acid diester, and/or hydroxyethyl methacrylate phosphoric acid diester, and (ii) polyether side chain structural units derived from C₁-C₄ alkyl-polyethylene glycol acrylic acid ester, polyethylene glycol acrylic acid ester, C₁-C₄ alkyl-polyethylene glycol methacrylic acid ester, polyethylene glycol methacrylic acid ester, C₁-C₄ alkyl-polyethylene glycol acrylic acid ester, polyethylene glycol acrylic acid ester, vinyloxy-C₂-C₄ alkylene-polyethylene glycol, vinyloxy-C₂-C₄ alkylene-polyethylene glycol C₁-C₄ alkyl ether, allyloxypolyethylene glycol, allyloxypolyethylene glycol C₁-C₄ alkyl ether, methallyloxy-polyethylene glycol, methallyloxy-polyethylene glycol C₁-C₄ alkyl ether, isoprenyloxy-polyethylene glycol and/or isoprenyloxy-polyethylene glycol C₁-C₄ alkyl ether.
   32. The additive of embodiment 31, where the comb polymer comprises structural units (i) and (ii) derived from
   (i) hydroxyethyl acrylate phosphoric acid ester and/or hydroxyethyl methacrylate phosphoric acid ester and (ii) C₁-C₄ alkyl-polyethylene glycol acrylic acid ester and/or C₁-C₄ alkyl-polyethylene glycol methacrylic acid ester; or
   (i) acrylic acid and/or methacrylic acid and (ii) C₁-C₄ alkyl-polyethylene glycol acrylic acid ester and/or C₁-C₄ alkyl-polyethylene glycol methacrylic acid ester; or
   (i) acrylic acid, methacrylic acid and/or maleic acid and (ii) vinyloxy-C₂-C₄ alkylene-polyethylene glycol, allyloxy-polyethylene glycol, methallyloxy-polyethylene glycol and/or isoprenyloxy-polyethylene glycol.
   33. The additive of embodiment 31, where the comb polymer comprises structural units (i) and (ii) derived from
   (i) hydroxyethyl methacrylate phosphoric acid ester and (ii) C₁-C₄ alkyl-polyethylene glycol methacrylic acid ester or polyethylene glycol methacrylic acid ester; or
   (i) methacrylic acid and (ii) C₁-C₄ alkyl-polyethylene glycol methacrylic acid ester or polyethylene glycol methacrylic acid ester; or
   (i) acrylic acid and maleic acid and (ii) vinyloxy-C₂-C₄ alkylene-polyethylene glycol or
   (i) acrylic acid and maleic acid and (ii) isoprenyloxy-polyethylene glycol or
   (i) acrylic acid and (ii) vinyloxy-C₂-C₄ alkylene-polyethylene glycol or
   (i) acrylic acid and (ii) isoprenyloxy-polyethylene glycol or
   (i) acrylic acid and (ii) methallyloxy-polyethylene glycol or
   (i) maleic acid and (ii) isoprenyloxy-polyethylene glycol or
   (i) maleic acid and (ii) allyloxy-polyethylene glycol or
   (i) maleic acid and (ii) methallyloxy-polyethylene glycol.
   34. The additive of any of embodiments 26 to 33, where the molar ratio of the structural units (I):(II) is 1:4 to 15:1, more particularly 1:1 to 10:1.
   35. The additive of any one of embodiments 1 to 21, wherein the comb polymer is a phosphorylated polycondensation product comprising structural units (III) and (IV):

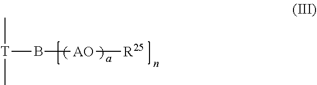

in which
T is a substituted or unsubstituted phenyl or naphthyl radical or a substituted or unsubstituted heteroaromatic radical having 5 to 10 ring atoms, of which 1 or 2 atoms are heteroatoms selected from N, O and S;
n is 1 or 2;
B is N, NH or O, with the proviso that n is 2 if B is N and with the proviso that n is 1 if B is NH or O;
A is an unbranched or branched alkylene with 2 to 5 carbon atoms or CH₂CH(C₆H₅);
a is selected such that the number average molecular weight of the moiety -(AO)ₐ- is in the range from 1000 to 5000;
R²⁵ is H, a branched or unbranched C₁ to C₁₀ alkyl radical, C₅ to C₈ cycloalkyl radical, aryl radical, or heteroaryl radical having 5 to 10 ring atoms, of which 1 or 2 atoms are heteroatoms selected from N, O and S;
where the structural unit (IV) is selected from the structural units (IVa) and (IVb):

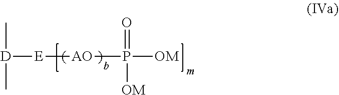

in which
D is a substituted or unsubstituted phenyl or naphthyl radical or a substituted or unsubstituted heteroaromatic radical having 5 to 10 ring atoms, of which 1 or 2 atoms are heteroatoms selected from N, O and S;
E is N, NH or O, with the proviso that m is 2 if E is N and with the proviso that m is 1 if E is NH or O;
A is an unbranched or branched alkylene with 2 to 5 carbon atoms or CH₂CH(C₆H₅);
b is selected such that the number average molecular weight of the moiety -(AO)_{b}- is in the range from 1000 to 5000;
M independently at each occurrence is H or a cation equivalent;

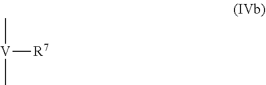

in which
V is a substituted or unsubstituted phenyl or naphthyl radical and is optionally substituted by 1 or two radicals selected from R⁸, OH, OR⁸, (CO)R⁸, COOM, COOR⁸, SO₃R⁸ and NO₂;
R⁷ is COOM, OCH₂COOM, SO₃M or OPO₃M₂;
M is H or a cation equivalent; and
R⁸ is C₁-C₄ alkyl, phenyl, naphthyl, phenyl-C₁-C₄ alkyl or C₁-C₄ alkylphenyl.
   36. The additive of embodiment 35, where, in formula Ill, T is a substituted or unsubstituted phenyl radical or naphthyl radical, A is CₓH₂ₓ with x=2 and/or 3, a is as defined in embodiment 35, and R²⁵ is H, or a branched or unbranched C₁ to C₁₀ alkyl radical.
   37. The additive of embodiment 35, where, in formula IVa, D is a substituted or unsubstituted phenyl radical or naphthyl radical, E is NH or O, A is CₓH₂ₓ with x=2 and/or 3, and b is as defined in embodiment 35.
   38. The additive of any one of embodiments 35 to 37, where T and/or D are phenyl or naphthyl which is substituted by 1 or 2 C₁-C₄ alkyl, hydroxyl or 2 C₁-C₄ alkoxy groups.
   39. The additive of embodiment 35, where V is phenyl or naphthyl which is substituted by 1 or 2 C₁-C₄ alkyl, OH, OCH₃ or COOM, and R⁷ is COOM or OCH₂COOM.
   40. The additive of any one of embodiments 35 to 39, where the polycondensation product comprises a further structural unit (V) of the formula

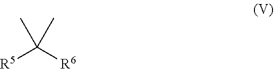

in which
R⁵ and R⁶ may be identical or different and are H, CH₃, COOH or a substituted or unsubstituted phenyl or naphthyl group or are a substituted or unsubstituted heteroaromatic group having 5 to 10 ring atoms, of which 1 or 2 atoms are heteroatoms selected from N, O and S.
41. The additive of embodiment 40, in which R⁵ and R⁶ may be identical or different and are H, CH₃, or COOH, more particularly H, or one of the radicals R⁵ and R⁶ is H and the other is CH₃.
42. The additive of any of the preceding embodiments, where the polyether moieties of the polyether side chains have a number average molecular weight of ≥1000 g/mol, preferably ≥1100 g/mol and 55000 g/mol, preferably 4000 g/mol.
43. The additive of embodiment 42, where the polyether moieties of the polyether side chains have a number average molecular weight in the range from 1000-5000 g/mol, preferably 1100-5000 g/mol and, in particular 1100 to 4000 g/mol.
44. The additive of any of the preceding embodiments, where the charge density of the comb polymer is in the range from 0.8 meq/g-3 meq/g polymer, preferably 1.5 meq/g-2.5 meq/g polymer.
45. The additive of any of the preceding embodiments, additionally comprising a hardening accelerator, in particular calcium silicate hydrate and/or soluble calcium salts like calcium chloride, calcium nitrate, calcium formate and/or calcium oxide and/or lithium salts like lithium carbonate, lithium sulfate, lithium hydroxide.
46. The additive of embodiment 45, where the calcium silicate hydrate is obtainable by reacting a water-soluble calcium compound with a water-soluble silicate compound in the presence of an aqueous solution of a water-soluble comb polymer or by reacting a calcium compound with a silicon dioxide in the presence of an aqueous solution of a water-soluble comb polymer.
47. The additive of any of the preceding embodiments as a powder.
48. The additive of embodiment 47 obtainable by spray drying.
49. A construction chemical composition which comprises the additive of embodiments 1 to 48 and an inorganic binder.
50. The construction chemical composition of embodiment 47, wherein the inorganic binder is selected from a latent hydraulic binder, a hydraulic binder or a calcium sulfate-based binder or a mixture thereof.
51. The construction chemical composition of embodiment 50, wherein the hydraulic binder is an aluminate-containing cement.
52. The construction chemical composition of embodiment 51, wherein the aluminate-containing cement is selected from CEM cement, in particular Portland cement and aluminate cement, in particular high alumina cement and sulfoaluminate cement, and mixtures thereof.
53. The construction chemical composition of embodiment 52, wherein the aluminate-containing cement is CEM cement, in particular Portland cement.
54. The construction chemical composition of embodiment 53, wherein the aluminate-containing cement is a mixture of CEM cement and aluminate cement, in particular a mixture of CEM cement and high alumina cement or a mixture of CEM cement and sulfoaluminate cement or a mixture of CEM cement, high alumina cement and sulfoaluminate cement.
55. The construction chemical composition of embodiment 49, wherein the inorganic binder is calcium sulfate hemihydrate or anhydrite and mixtures thereof.
56. The construction chemical composition of embodiment 49, wherein the inorganic binder is a mixture of an aluminate-containing cement and a calcium sulfate-based binder.
57. The construction chemical composition of any one of embodiments 49 to 56, additionally comprising at least one dispersant, in particular a polycarboxylate ether, phosphorous containing dispersants or a sulfonic acid and/or sulfonate group containing dispersant.
58. The construction chemical composition of any one of embodiments 49 to 57, additionally comprising an additive which is selected from essentially aluminate-free cement, fillers, and aggregates or a mixture of two or more thereof.
59. The construction chemical composition of any one of embodiments 49 to 58, additionally comprising an inorganic alkali metal carbonate selected from sodium carbonate, potassium carbonate, lithium carbonate or a mixture thereof.
60. The construction chemical composition of any one of embodiments 49 to 59, wherein the weight ratio of the inorganic binder to the additive according to claim 1 to 3 is in the range from 10:1 to 100000:1.
61. The construction chemical composition of any one of embodiments 49 to 60 in the form of a powder mixture.
61. The use of the additive as defined in any one of embodiments 1 to 48 for retarding the hardening of inorganic binder containing building material formulations and/or for producing building products, in particular concretes such as on-site concrete, finished concrete parts, pre-cast concrete parts, concrete goods, cast concrete stones, concrete bricks, in-situ concrete, sprayed concrete (shotcrete), ready-mix concrete, air-placed concrete, concrete repair systems, industrial cement flooring, one-component and two-component sealing slurries, screeds, filling and self-levelling compositions, such as joint fillers or self-levelling underlayments, adhesives, such as building or construction adhesives, thermal insulation composite system adhesives, or tile adhesives, renders, plasters, sealants, coating and paint systems, in particular for tunnels, waste water drains, splash protection and condensate lines, screeds, mortars, such as dry mortars, sag resistant, flowable or self-levelling mortars, drainage mortars, or repair mortars, grouts, such as joint grouts, non shrink grouts, tile grouts, wind-mill grouts, anchor grouts, flowable or self-levelling grouts, ETICS (external thermal insulation composite systems), EIFS grouts (Exterior Insulation Finishing Systems, swelling explosives, waterproofing membranes, cementitious foams, or gypsum wall boards.

### The Additive

### Component (a): The Amide or Ester of a Sugar Acid

Suitable amides and esters are, for example, known from WO 00/44487 and WO 01/04185.

Preferred are esters and amides of gluconic acid. They can be prepared by reacting a sugar lactone with a suitable amine or alcohol in a conventional manner. Alternatively, a sugar acid may be esterified with a suitable alcohol or amidated with a suitable amine. In the preferred amides and esters R⁴ is -(AO)ₓ—R⁵ with A being ethylene (—CH₂CH₂—) and/or —CH(CH₃)—CH₂—. x is preferably 1 to 80, in particular 1 to 60.

### Component (b): The Water-Soluble Comb Polymer

“Water-soluble comb polymer” as used herein means a polymer comprising a polymer backbone comprising units with acid functions (anionic and/or anionogenic groups), in particular carboxylic acid groups, and units carrying a side chain having ether functions. Such units are defined in detail in the embodiments given above.

The comb polymers are more preferably selected from the group of polycarboxylate ethers (PCEs), the anionic group being in the case of PCEs carboxylic groups and/or carboxylate groups. The comb polymers as used herein and their preparation are known, for example from WO 2010/026155. They are preferably produced by a radical copolymerization of a polyether macromonomer and an acid monomer in a way that at least 45 mol-%, preferably at least 80 mol-% of all structural units of the copolymer were formed by copolymerization of the polyether macromonomer and the acid monomer. The term acid monomer means in particular a monomer comprising anionic and/or anionogenic groups. The term polyether macromonomer means in particular a monomer comprising at least two ether groups, preferably at least two alkylene glycol groups.

The amount of acid functions in the polymer is such that the charge density is in the range from 1 meq/g-5 meq/g polymer, preferably 1 meq/g-3 meq/g polymer. Charge density of the polymer was calculated assuming that all acid groups (sulfonate, phosphate and Carboxylate) are fully deprotonated. Charge density p is calculated with

$$ρ = \frac{N ( neg . charges )}{m}$$

(N=number of negative charges; m=total mass of polymer).

“Water-soluble” means a polymer having a solubility in water at 20° C. and normal pressure of at least 1 g/l, in particular at least 10 g/l and preferably at least 100 g/l.

The weight ratio of component (a) (amide or ester of a sugar acid) to component (b) (water-soluble comb polymer) is in the range from 10:1 to 1:5.

### Construction Chemical Compositions

The present invention further relates to construction chemical compositions which comprise the additive of the invention and at least one inorganic binder.

In an embodiment, the additive is contained in the construction chemical compositions in an amount of 0.01 to 5% by weight, based on the weight of the inorganic binder.

In another embodiment, the inorganic binder is selected from a latent hydraulic binder, a hydraulic binder or a calcium sulfate-based binder or mixtures thereof.

In an embodiment, the inorganic binder is selected from calciumsulfate hemihydrate, anhydrite and/or aluminate-containing cement.

Aluminate-containing cement here means that the cement contains aluminate phases such as tricalcium aluminate (C₃A), monocalcium aluminate (CA), tetra aluminate ferrate (C₄AF), dodecacalcium heptaaluminate (C₁₂A₇), yeelimite (C₄A₃s) etc. The amount of aluminate phases is ≥0.1% by weight of the aluminate-containing cement. The content of Al₂O₃ in the aluminate-containing cement is ≥0.05% by weight of the aluminate-containing cement.

In another embodiment, the aluminate-containing cement is selected from CEM cement and aluminate cement, in particular high alumina cement and sulfoaluminate cement, and mixtures thereof. CEM cement is a cement in accordance with the CEM classification as set forth for example in DIN EN 197-1. A preferred cement is ordinary Portland cement (OPC) according to DIN EN 197-1 which may either contain calcium sulfate (<7% by weight) or is essentially free of calcium sulfate (<1% by weight). Another preferred cement is sulfoaluminate cement (calcium sulfoaluminate cement, CSA) or high alumina cement (HAC) according to DIN EN 14647 or a mixture of ordinary Portland cement and aluminate cement, in particular a mixture of ordinary Portland cement and high alumina cement or a mixture of ordinary Portland cement and sulfoaluminate cement or a mixture of ordinary Portland cement, high alumina cement and sulfoaluminate cement.

It has been surprisingly found that the additive according to formula (I) is useful as retarder for the hydration of anhydrous inorganic binders resulting in the formation of hydrate phases connected with the hardening of the inorganic binders. In the case of calcium sulfate hemihydrate and anhydrite the formation of gypsum is influenced by the additive of the invention. In the case of aluminate-containing cements the additive is influencing the aluminate reaction. Aluminate reaction means the hydration of aluminate-containing clinker phases like for example tricalcium aluminate (C₃A), monocalcium aluminate (CA), tetra aluminate ferrate (C₄AF), dodecacalcium heptaaluminate (C₁₂A₇), yeelimite (C₄A₃s) under formation of calcium aluminate hydrates. The hydration reactions are described in Lea's Chemistry of Cement and Concrete (4^{th} edition), 2007 on pages 241-274 (hydration of Portland cement) and 722-735 (hydration of calcium aluminate cement). The hydration reaction of aluminate-containing clinker phases is retarded which is required to avoid a too rapid setting of mortar and concrete pastes and to ensure a sufficient open time which allows processing the pastes as desired.

In a further embodiment, the inorganic binder is a calcium sulfate-based binder. In a further embodiment, the calcium sulfate based binder is selected from the group consisting of anhydrite, α- and β-hemihydrate, i.e. α-bassanite and β-bassanite, or mixtures thereof. Preferably the calcium sulfate-based binder is α-bassanite and/or β-bassanite.

In an embodiment, where the construction chemical compositions contain an aluminate-containing cement, the compositions may additionally contain at least one calcium sulfate which is selected from the group consisting of calcium sulfate dihydrate, anhydrite, α- and β-hemihydrate, i.e. α-bassanite and β-bassanite, or mixtures thereof. Preferably the calcium sulfate is α-bassanite, β-bassanite and/or anhydrite. In general, calcium sulfate is comprised in an amount of about 1 to about 20 wt %, based on the weight of the aluminate-containing cement.

In an embodiment, the construction chemical compositions additionally contain at least one alkali metal sulfate like potassium sulfate or sodium sulfate, in particular in case the inorganic binder is calcium sulfate hemihydrate like α- and β-hemihydrate or anhydrite.

In a further embodiment, the inorganic binder comprises a mixture of at least one aluminate-containing cement and at least one calcium sulfate-based binder.

In another embodiment, the construction chemical compositions additionally contain at least one alkali metal carbonate, in particular sodium and/or potassium carbonate. The alkali metal carbonate is, in general, comprised in an amount in the range from about 1 to about 20 wt %, based on the weight of the inorganic binder.

The construction chemical compositions may also contain latent hydraulic binders. For the purposes of the present invention, a “latent hydraulic binder” is preferably a binder in which the molar ratio (CaO+MgO):SiO₂ is from 0.8 to 2.5 and particularly from 1.0 to 2.0. In general terms, the above-mentioned latent hydraulic binders can be selected from industrial and/or synthetic slag, in particular from blast furnace slag, electrothermal phosphorous slag, steel slag and mixtures thereof, and the “pozzolanic binders” can generally be selected from amorphous silica, preferably precipitated silica, fumed silica and microsilica, ground glass, metakaolin, aluminosilicates, fly ash, preferably brown-coal fly ash and hard-coal fly ash, natural pozzolans such as tuff, trass and volcanic ash, natural and synthetic zeolites and mixtures thereof.

The slag can be either industrial slag, i.e. waste products from industrial processes, or else synthetic slag. The latter can be advantageous because industrial slag is not always available in consistent quantity and quality.

Blast furnace slag (BFS) is a waste product of the glass furnace process. Other materials are granulated blast furnace slag (GBFS) and ground granulated blast furnace slag (GGBFS), which is granulated blast furnace slag that has been finely pulverized. Ground granulated blast furnace slag varies in terms of grinding fineness and grain size distribution, which depend on origin and treatment method, and grinding fineness influences reactivity here. The Blaine value is used as parameter for grinding fineness, and typically has an order of magnitude of from 200 to 1000 m² kg⁻¹, preferably from 300 to 500 m² kg⁻¹. Finer milling gives higher reactivity.

For the purposes of the present invention, the expression “blast furnace slag” is however intended to comprise materials resulting from all of the levels of treatment, milling, and quality mentioned (i.e. BFS, GBFS and GGBFS). Blast furnace slag generally comprises from 30 to 45% by weight of CaO, about 4 to 17% by weight of MgO, about 30 to 45% by weight of SiO₂ and about 5 to 15% by weight of Al₂O₃, typically about 40% by weight of CaO, about 10% by weight of MgO, about 35% by weight of SiO₂ and about 12% by weight of Al₂O₃.

Electrothermal phosphorous slag is a waste product of electrothermal phosphorous production. It is less reactive than blast furnace slag and comprises about 45 to 50% by weight of CaO, about 0.5 to 3% by weight of MgO, about 38 to 43% by weight of SiO₂, about 2 to 5% by weight of Al₂O₃ and about 0.2 to 3% by weight of Fe₂O₃, and also fluoride and phosphate. Steel slag is a waste product of various steel production processes with greatly varying composition.

Amorphous silica is preferably an X-ray-amorphous silica, i.e. a silica for which the powder diffraction method reveals no crystallinity. The content of SiO₂ in the amorphous silica of the invention is advantageously at least 80% by weight, preferably at least 90% by weight. Precipitated silica is obtained on an industrial scale by way of precipitating processes starting from water glass. Precipitated silica from some production processes is also called silica gel.

Fumed silica is produced via reaction of chlorosilanes, for example silicon tetrachloride, in a hydrogen/oxygen flame. Fumed silica is an amorphous SiO₂ powder of particle diameter from 5 to 50 nm with specific surface area of from 50 to 600 m²g⁻¹.

Microsilica is a by-product of silicon production or ferrosilicon production, and likewise consists mostly of amorphous SiO₂ powder. The particles have diameters of the order of magnitude of 0.1 μm. Specific surface area is of the order of magnitude of from 15 to 30 m² g⁻¹.

Fly ash is produced inter alia during the combustion of coal in power stations. Class C fly ash (brown-coal fly ash) comprises according to WO 08/012438 about 10% by weight of CaO, whereas class F fly ash (hard-coal fly ash) comprises less than 8% by weight, preferably less than 4% by weight, and typically about 2% by weight of CaO.

Metakaolin is produced when kaolin is dehydrated. Whereas at from 100 to 200° C. kaolin releases physically bound water, at from 500 to 800° C. a dihydroxylation takes place, with collapse of the lattice structure and formation of metakaolin (Al₂Si₂O₇). Accordingly pure metakaolin comprises about 54% by weight of SiO₂ and about 46% by weight of Al₂O₃.

For the purposes of the present invention, aluminosilicates are the abovementioned reactive compounds based on SiO₂ in conjunction with Al₂O₃ which harden in an aqueous alkali environment. It is of course not essential here that silicon and aluminium are present in oxidic form, as is the case by way of example in Al₂Si₂O₇. However, for the purposes of quantitative chemical analysis of aluminosilicates it is usual to state the proportions of silicon and aluminium in oxidic form (i.e. as “SiO₂” and “Al₂O₃”).

In an embodiment, the latent hydraulic binder is selected from the group consisting of blast furnace slag, microsilica, metakaolin, aluminosilicates, fly ash and mixtures thereof.

The latent hydraulic binder is, in general, comprised in an amount in the range from about 1 to about 30 wt %, based on the weight of the aluminate-containing cement.

In an embodiment, the construction chemical compositions additionally include conventional retarders, such as citric acid, tartaric acid, sodium gluconate, phosphates etc.

In another embodiment, the compositions comprise at least one hardening accelerator. A preferred hardening accelerator is a calcium-silicate-hydrate (CSH) based hardening accelerator for compositions comprising OPC.

The calcium-silicate-hydrate may contain foreign ions, such as magnesium and aluminium.

The calcium-silicate-hydrate can be preferably described with regard to its composition by the following empirical formula:
a CaO, SiO₂, b Al₂O₃, c H₂O, d X, e W
X is an alkali metal
W is an alkaline earth metal

| | | |
|---|---|---|
| 0.1 ≤ a ≤ 2 | preferably | 0.66 ≤ a ≤ 1.8 |
| 0 ≤ b ≤ 1 | preferably | 0 ≤ b ≤ 0.1 |
| 1 ≤ c ≤ 6 | preferably | 1 ≤ c ≤ 6.0 |
| 0 ≤ d ≤ 1 | preferably | 0 ≤ d ≤ 0.4 or 0.2 |
| 0 ≤ e ≤ 2 | preferably | 0 ≤ e ≤ 0.1 |

Calcium-silicate-hydrate can be obtained preferably by reaction of a calcium compound with a silicate compound, preferably in the presence of a polycarboxylate ether (PCE). Such products containing calcium-silicate-hydrate are for example described in WO 2010/026155 A1, EP 14198721, WO 2014/114784 or WO 2014/114782.

Preferable is a composition, preferably dry mortar composition, in which the calcium-silicate-hydrate based hardening accelerator for cementitious compositions is a powder product.

Powder products are advantageous as they are naturally high in contents of calcium-silicate-hydrate. In particular there are no compatibility problems with for example cement or other hydraulic binders, which might react with water from the aqueous calcium-silicate-hydrate containing suspension during storage.

The water content of the calcium-silicate-hydrate based hardening accelerator in powder form is preferably from 0.1 weight % to 5.5 weight % with respect to the total weight of the powder sample. Said water content is measured by putting a sample into a drying chamber at 80° C. until the weight of the sample becomes constant. The difference in weight of the sample before and after the drying treatment is the weight of water contained in the sample. The water content (%) is calculated as the weight of water contained in the sample divided with the weight of the sample.

A composition is preferred in which the calcium-silicate-hydrate based hardening accelerator is an aqueous suspension. The water content of the aqueous suspension is preferably from 10 weight % to 95 weight %, preferably from 40 weight % to 90 weight %, more preferably from 50 weight % to 85 weight %, in each case the percentage is given with respect to the total weight of the aqueous suspension sample. The water content is determined in an analogous way as described in the before standing text by use of a drying chamber.

Further useful hardening accelerators for aluminate-containing cements are calcium formate, calcium nitrate, calcium chloride, lithium carbonate and lithium sulfate.

Further useful hardening accelerators for inorganic binders selected from calciumsulfate hemihydrate and/or anhydrite are potassium sulfate, sodium sulfate and ground gypsum (known to the skilled person as ball mill accelerator).

Above mentioned hardening accelerators can be used as single accelerator or as mixture.

The construction chemical composition may additionally contain an essentially aluminate-free cement, anionic starch ethers, cellulose ethers, a redispersible polymer powder, and fillers or a mixture of two or more thereof. The term “essentially free” means here less than 5 wt %, preferably less than 3 wt % and in particular less than 1 wt %, based on the weight of the aluminate-containing cement.

An anionic starch ether is in particular carboxymethyl starch ether. Cellulose ethers are preferably selected from the group consisting of methylcellulose, ethylcellulose, propylcellulose, methylethylcellulose, hydroxyethylcellulose (HEC), hydroxypropylcellulose (HPC), hydroxyethylhydroxypropylcellulose, methylhydroxyethylcelluose (MHEC), methylhydroxypropylcelluose (MHPC) and propylhydroxypropylcellulose or mixtures of two or more thereof and in particular from the group consisting of carboxymethyl cellulose, methyl cellulose, methyl hydroxypropyl cellulose, methyl hydroxyethyl cellulose or mixtures of two or more thereof.

Redispersible polymer powders are preferably selected from the group consisting of vinyl acetate polymer, vinyl acetate-ethylene copolymer, vinyl acetate-vinyl ester copolymer and/or vinyl acetate-vinyl ester-ethylene copolymer, with the vinyl ester monomers in each case being selected from the group consisting of vinyl laurate, vinyl pivalate and vinyl versatates, vinyl acetate-acrylic ester copolymer, vinyl acetate-acrylic ester-ethylene copolymer, styrene-butadiene copolymer and styrene-acrylic ester copolymer, with the acrylic esters in each case being esters with branched or linear alcohols containing from 1 to 10 carbon atoms and in particular from the group consisting of styrene acrylate copolymer, polyvinyl acetate, styrene butadiene copolymer or mixtures of two or more thereof.

Fillers are preferably inert materials, which do not act as binder and basically do not dissolve in water. The solubility in water is preferably below 3 g/l at 20° C. and normal pressure. Preferred fillers are limestone, quartz flower, sand, silica dust and basalt powder. Fillers can be preferably present in the composition from 1 weight % to 80 weight %, preferably from 10 weight % to 80 weight %, more preferably 30 weight % to 70 weight % with respect to the total weight of the composition.

In an embodiment, the construction chemical composition is in form of a powder mixture.

In another embodiment, the invention relates to a construction chemical composition comprising

a) the additive of the invention as defined above, and
b) ordinary Portland cement.

The content of a) in this embodiment is 0.01 wt.-%-5.0 wt.-% by weight of b).

In another embodiment, the invention relates to a construction chemical composition comprising

a) the additive of the invention as defined above, and
b) calcium sulfate hemihydrate or anhydrite.

The content of a) in this embodiment is 0.01 wt.-%-5.0 wt.-% by weight of b).

In another embodiment, the invention relates to a construction chemical composition comprising

a) the additive of the invention as defined above,
b) ordinary Portland cement, or calcium sulfate, in particular calcium sulfate dihydrate, calcium sulfate hemihydrate or anhydrite and
c) aluminate cement, in particular high alumina cement and sulfoaluminate cement and mixtures thereof.

The content of a) in this embodiment is 0.01 wt.-%-5.0 wt.-% by weight of sum of b) and c). The content of the sum of b) and c) in the construction chemical composition is 10-95 wt.-%. The weight ratio b)/c) is 5/95 to 95/5.

In another embodiment, the invention relates to a construction chemical composition comprising

a) the additive of the invention as defined above,
b) ordinary Portland cement,
c) aluminate cement, in particular high alumina cement and sulfoaluminate cement and mixtures thereof; and
d) calcium sulfate, in particular calcium sulfate dihydrate, calcium sulfate hemihydrate or anhydrite.

The content of a) in this embodiment is 0.01 wt.-%-5.0 wt.-% by weight of sum of b), c), and d). The content of the sum of b), c), and d) in the construction chemical composition is 10-95 wt.-%. The weight ratio b)/c) is 5/95 to 95/5. The weight ratio c)/d) is 100/1 to 2/1.

The invention also concerns the use of the additive of the invention as a retarder for aluminate-containing building material formulations and/or for producing building products, in particular for concretes such as on-site concrete, finished concrete parts, pre-cast concrete parts, concrete goods, cast concrete stones, concrete bricks, in-situ concrete, sprayed concrete (shotcrete), ready-mix concrete, air-placed concrete, concrete repair systems, industrial cement flooring, one-component and two-component sealing slurries, screeds, filling and self-levelling compositions, such as joint fillers or self-levelling underlayments, adhesives, such as building or construction adhesives, thermal insulation composite system adhesives, tile adhesives, renders, plasters, sealants, coating and paint systems, in particular for tunnels, waste water drains, splash protection and condensate lines, screeds, mortars, such as dry mortars, sag resistant, flowable or self-levelling mortars, drainage mortars, or repair mortars, grouts, such as joint grouts, non shrink grouts, tile grouts, wind-mill grouts, anchor grouts, flowable or self-levelling grouts, ETICS (external thermal insulation composite systems), EIFS grouts (Exterior Insulation Finishing Systems), swelling explosives, waterproofing membranes, cementitious foams or gypsum wall boards.

The following examples illustrate the invention.

Any molecular weight given herein is the average molecular weight M_{w} as determined by gel permeation chromatography (GPC). The molecular weights of the polymers were determined by using gel permeation chromatography (GPC) as described below.

Column combination: OH-Pak SB-G, OH-Pak SB 804 HQ and OH-Pak SB 802.5 HQ by Shodex, Japan; eluent: 80 vol.-% aqueous solution of HCO₂NH₄ (0.05 mol/I) and 20 vol.-% acetonitrile; injection volume 100 μl; flow rate 0.5 ml/min. The molecular weight calibration was performed with poly(ethylene oxide) standards for the RI detector. Standards were purchased from PSS Polymer Standards Service, Germany. To determine the molecular weight an RI detector was used.

### Synthesis of Component (a) (Sugar Derivatives)

Components (a) were synthesized by reacting gluconolactone (anchor group) as sugar acid precursor with the compound from which the amide or ester group is derived (sugar side chain). For comparative purposes conventional retarders (citric acid, tartaric acid and succinic acid anhydride) were used as anchor group and were reacted with said compound. A glass flask is charged with 1 mol-equivalent of the sugar side chain and 1 mol-equivalent of the anchor group under nitrogen. The educt mixture is heated to 130° C. and stirred at this temperature for four hours. Thereafter, the mixture is diluted with water and the degree of conversion is determined using HPLC. The educts are given in table 1 below.

TABLE 1

| Sugar | | |
|---|---|---|
| derivative | Side chain | Anchor group |
| 1 | Jeffamin M1000 | Gluconolactone |
| 2 | Jeffamin M 2070 | Gluconolactone |
| 3 | MPEG 2000-i-BO | Gluconolactone |
| 4 | Diethanolamine | Gluconolactone |
| 5 | MPEG-500-PO | Gluconolactone |
| 6 | Genamin M 41/2000 | Gluconolactone |
| 7 | Jeffamin D 400 | Gluconolactone |
| 8 | Jeffamin M 600 | Gluconolactone |
| V1 | Jeffamin M1000 | Citric acid |
| V2 | Jeffamin M1000 | Succinic acid anhydride |

Jeffamin M1000: 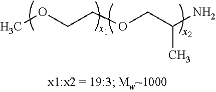
Jeffamine M2070: 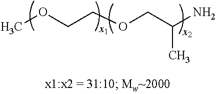
Jeffamine M600: 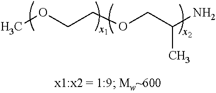
Jeffamine D400: 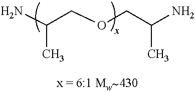
Genamine M 41/2000: 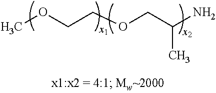
MPEG-500-PO: 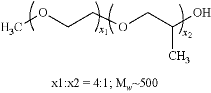
MPEG 2000-i-BO:

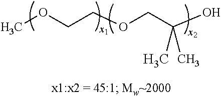

### APPLICATION EXAMPLES

The additives were tested in cement mortar using the following polymers as water-soluble comb polymer:

Polymer 1: A polymer from radical polymerization of ethoxylated hydroxybutyl monovinylether with 67 EO and 10 equivalents of acrylic acid per ethoxylated side chain.
Polymer 2: A phosphate-based polyether (example 2, WO15091461A1).
Polymer 3: Melamine-Sulfonate-Formaldehyde resin (Melment F10).
Polymer 4: Naphthalene sulfonic acid-formaldehyde condensation product (Melcret 500 L).
Polymer 5: A polymer from radical polymerization of ethoxylated hydroxybutyl monovinylether with 67 EO and 5 equivalents of acrylic acid per ethoxylated side chain.

Polymers 3 and 4 are comparative polymers.

The cement mortar contained 50.0 wt % of Portland cement (CEM I 52,5 N, Milke) und 50.0 wt % norm sand (DIN EN 196-1). The water/cement weight ratio was 0.30. The water-soluble comb polymer and the sugar derivatives of table 1 were added to the mortar in the amounts given in table 2.

The cement mortar was prepared on the basis of the method described in DIN EN 196-1:2005 in a 5 L RILEM mixer. The mixer was charged with water, additive and then cement. Thereafter, mixing was started at low speed (140 rpm). After 30 s norm sand was uniformly added to the mixture within 30 s. The mixing speed was then increased (285 rpm) and continued for 30 s. The mixing was then stopped for 90 s and thereafter continued for 60 s at 285 rpm. The total mixing time was 4 min.

Immediately after the mixing process the slump flow of the samples was determined using the Haegermann conus without applying compression energy. The testing method was on the basis of SVB-Richtlinie des Deutschen Ausschusses für Stahlbeton (Deutscher Ausschuss für Stahlbetonbau (Ed.): DAfStb—Richtlinie Selbstverdichtender Beton (SVB—Richtlinie) Berlin, 2003). The Haegermann conus (d at the top=70 mm, d at the bottom=100 mm, h=60 mm) was placed in the middle of a dry glass plate having a diameter of 400 mm and filled with the cement mortar. 5 min. after the first contact between cement and water the conus was removed and the average diameter of the cake formed was determined. In order to follow the development of slump flow the test was repeated after the mortar was allowed to stand for 10, 30 and 60 min. Prior to each test the mortar was remixed for 10 s at 140 rpm. The results are given in tables 2 to 4 (bwoc: by weight of cement).

TABLE 2

| | | Amount | | | | | |
|---|---|---|---|---|---|---|---|
| | Polymer | of Sugar | Slump flow SF [cm] | | | | delta |
| Sugar | 1 | derivative | 5 | 10 | 30 | 60 | SF |
| derivative | [% bwoc] | [% bwoc] | min | min | min | min. | [cm] |
| 1 | 0 | 0.05 | — | — | — | — | — |
| — | 0.216 | 0 | 27.3 | 19.7 | 12.3 | 12.1 | 15.2 |
| 1 | 0.182 | 0.05 | 26.7 | 21.7 | 19.9 | 19.1 | 7.6 |
| 2 | 0.189 | 0.05 | 25.7 | 19.3 | 18.2 | 17.7 | 8 |
| 3 | 0.181 | 0.05 | 25.6 | 19.5 | 13.9 | 12.5 | 13.1 |
| 4 | 0.155 | 0.05 | 25.1 | 24.1 | 18.5 | 15.2 | 9.9 |
| 5 | 0.195 | 0.05 | 26.3 | 20.9 | 15.1 | 13.6 | 12.7 |
| 6 | 0.185 | 0.05 | 26.1 | 21.1 | 19.6 | 19.1 | 7 |
| 7 | 0.150 | 0.05 | 28.4 | 23.4 | 18.3 | 18.0 | 10.4 |
| 8 | 0.191 | 0.05 | 26.6 | 20.1 | 15.9 | 14.7 | 11.9 |
| Gluconolactone | 0.125 | 0.05 | 27.0 | 20.1 | 11.6 | 10.0 | 17 |
| Na-Gluconate | 0.150 | 0.05 | 28.7 | 22.2 | 15.2 | 10.8 | 17.9 |
| V1 | 0.216 | 0.05 | 32.5 | 25.4 | 19.8 | 17.7 | 14.8 |
| V2 | 0.216 | 0.05 | 22.1 | 16.0 | 10.8 | 10.0 | 12.1 |

Table 2 includes data for the use of the polymer alone and the sugar derivative alone. Further, it includes comparative data for the use of gluconolactone and sodium gluconate as sugar derivative. As can be seen, the use of the additive of the invention results in a reduced slump loss, i.e. an improved processing profile, due to a synergistic effect between the comb polymer and the sugar derivative.

The following table 3 describes the synergistic effect of PEG-containing polymers 1 and 2 with sugar derivative 1.

TABLE 3

| | | | Dosage | | 1d |
|---|---|---|---|---|---|
| | | Dosage | sugar | Delta | compressive |
| | Sugar | Polymer | derivative | slump | Strength |
| Polymer | derivative | [% ¹⁾] | [% ¹⁾] | [cm] | [MPa] |
| 1 | — | 0.223 | 0 | 15 | 38.0 |
| 1 | 1 | 0.148 | 0.1 | 3 | 36.1 |
| 1 | Sodium | 0.148 | 0.1 | 9 | 12.0 |
| | Gluconate | | (Sodium | | |
| | | | Gluconate) | | |
| 2 | — | 0.29 | 0 | 18 | 11.4 |
| 2 | 1 | 0.20 | 0.05 | 12 | 13.5 |
| 3 (compar- | — | 0.68 | 0 | 18 | 7.2 |
| ative) | | | | | |
| 3 (compar- | 1 | 0.67 | 0.1 | 18 | 6.9 |
| ative) | | | | | |

| | | |
|---|---|---|
| 4 (compar- | 1 | Formulation not possible |
| ative) | | |

¹⁾ % solid on cement

The application of the additives of the invention results in a better slump retention with only slight increase or even reduced overall dosage. In case of polymer 3 (melamine-formaldehyde resins (PEG-free)), the strongly increased overall dosage did not lead to a better slump retention. A formulation of sugar derivative 1 with polynaphthalene sulfonate was not possible due to a strong gelling.

Table 4 shows the influence of the charge density and side chain length of the comb polymer 1 on the performance of the retarder. The dosage of the comb polymer was adjusted to achieve a slump flow of 26 cm and the dosage of the sugar derivative 1 was adjusted to achieve a delta slump of <7 cm+/−1 cm after 60 min.

TABLE 4

| Acrylic acid | Ethoxylated | | Dosage PCE | Dosage 1 | Delta slump | 1d compressive |
|---|---|---|---|---|---|---|
| [eq. per ethoxy- | VOBPEG | Charge | [% solid on | [% solid on | [cm] after | strength |
| lated side chain] | [g/mol] | density | cement] | cement] | 60 minutes | [MPa] |
| 5 | 3000 | 1.49 | 0.12 | 0.05 | 2 | 44 |
| 5 | 3000 | 1.49 | 0.14 | | 12 | 42 |
| 3 | 3000 | 0.93 | 0.12 | 0.03 | 2 | 45 |
| 3 | 3000 | 0.93 | 0.14 | | 8 | 38 |
| 3 | 1100 | 2.46 | 0.14 | 0.1 | 1 | 51 |
| 3 | 1100 | 2.46 | 0.23 | | 10 | 37 |
| 2.5 | 1100 | 2.11 | 0.11 | 0.07 | 3 | 50 |
| 2.5 | 1100 | 2.11 | 0.15 | | 5 | 43 |
| 7 | 5800 | 1.11 | 0.05 | 0.5 | 5 | 40 |
| 7 | 5800 | 1.11 | 0.18 | | 14 | 48 |
| 5 | 5800 | 0.81 | 0.05 | 0.5 | 5 | 37 |
| 5 | 5800 | 0.81 | 0.15 | | 14 | 50 |
| 2 | 750 | 2.23 | 0.38 | 0.02 | 0 | 33 |
| 2 | 750 | 2.23 | 0.38 | | 2 | 35 |
| 2 | 500 | 3.10 | 0.42 | 0.02 | 0 | 28 |
| 2 | 500 | 3.10 | 0.42 | | 5 | 29 |

It can be seen that the best performance in terms of slump retention and early strength can be obtained when using a side chain length of 1000 g/mol to 5000 g/mol. In this range, the compressive strength increases when using a combination of comb polymer and sugar-compound. The best efficiency can be obtained using a polyethylene glycol side chain of about 3000 g/mol. Here, the dose efficiency of the retarder with respect to slump retention performance gain is highest.

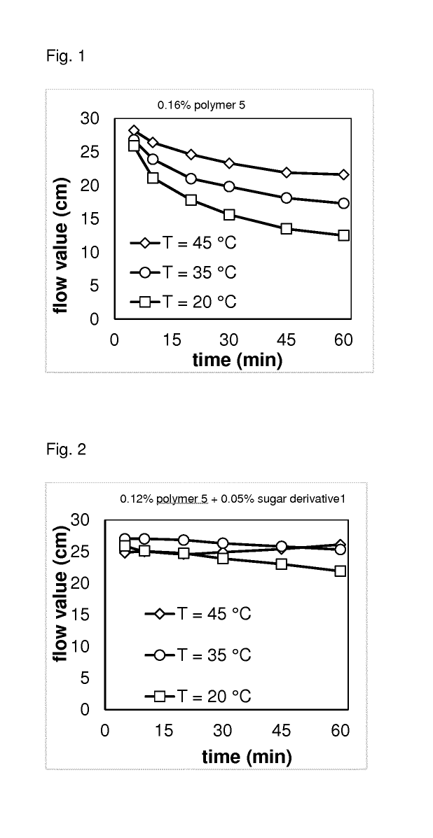

It is known that the slump flow activity of comb polymers is temperature dependent and decreases with decreasing temperature. Surprisingly, it has been found that the temperature dependency of the slump flow is significantly reduced when using the additive of the invention. This is shown in FIGS. 1 and 2 for the comb polymer 5. Whereas there is a significant temperature dependency if polymer 5 is used without any sugar derivative, there is practically no change in the flow value if polymer 5 is used together with sugar derivative 1.

1: An additive, suitable for construction chemical compositions and comprising:
a) at least one amide or ester of a sugar acid and
b) at least one water-soluble comb polymer which comprises, on the main chain, acid functions and side chains comprising polyether moieties, wherein the polyether moieties have a number average molecular weight in a range of from 1000 to 5000 g/mole.

2: The additive of claim 1, comprising an amide or ester of a sugar acid having formula (I): 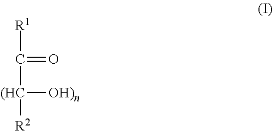
wherein
R¹ is —NR³R⁴ or —OR⁴;
R² is —CH₂OH, —COOH or —COR¹;
R³ is H, C₁-C₆-alkyl, hydroxy-C₁-C₆-alkyl or -(AO)ₓ—R⁵;
R⁴ is -(AO)ₓ—R⁵, C₁-C₆-alkyl or hydroxy-C₁-C₆-alkyl;
R⁵ is H, C₁-C₁₂-alkyl, C₁-C₁₂-alkyl substituted by —NH₂ or —X—CO—(CHOH)n-R²;
X is —NH— or —O—;
A at each occurrence may be the same or different and is CₘH₂ₘ;
m is 2, 3, 4, 5 or 6;
n is 2, 3, 4, or 5; and
x is 1 to 100.

3: The additive of claim 2, wherein the amide or ester of the sugar acid having formula (I) comprises at least one group -(AO)ₓ—R⁵.

4: The additive of claim 2, comprising an amide or ester of a sugar acid having formula (I) wherein R¹ is —NR³R⁴, R³ is H or C₁-C₆-alkyl, R⁴ is -(AO)ₓ—R⁵ and R⁵ is H, C₁-C₄-alkyl or C₁-C₄-alkyl substituted by —NH₂.

5: The additive of claim 2, comprising an amide or ester of a sugar acid having formula (I) wherein R² is —CH₂OH.

6: The additive of claim 2, comprising an amide or ester of a sugar acid having formula (I) wherein R¹ is —NR³R⁴, n is 4, R² is —CH₂OH, R³ is H, R⁴ is -(AO)ₓ—R⁵, and R⁵ is H or C₁-C₄-alkyl.

7: The additive of claim 2, comprising an amide or ester of a sugar acid having formula (I) wherein R¹ is —NR³R⁴ and R³ and R⁴ are hydroxy-C₁-C₆-alkyl.

8: The additive of claim 2, comprising an amide or ester of a sugar acid having formula (I) wherein R¹ is —OR⁴, R⁴ is -(AO)ₓ—R⁵ and R⁵ is H or C₁-C₁₂-alkyl.

9: The additive of claim 1, wherein the at least one water-soluble comb polymer comprises as units having acid functions at least one structural unit of the general formulae (Ia), (Ib), (Ic) and/or (Id): 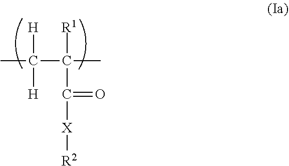
in which
R¹ is H or an unbranched or branched C₁-C₄ alkyl group, CH₂COOH or CH₂CO—X—R²;
X is NH—(CₙH₂ₙ), O(CₙH₂ₙ) with n=1, 2, 3 or 4, where the nitrogen atom or the oxygen atom is bonded to the CO group, or is a chemical bond;
R² is OM, PO₃M₂, or O—PO₃M₂, with the proviso that X is a chemical bond if R² is OM; 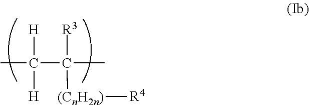
in which
R³ is H or an unbranched or branched C₁-C₄ alkyl group;
n is 0, 1, 2, 3 or 4;
R⁴ is PO₃M₂, or O—PO₃M₂; 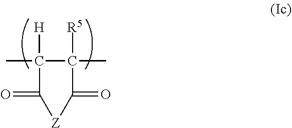
in which
R⁵ is H or an unbranched or branched C₁-C₄ alkyl group;
Z is O or NR⁷;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and
n is 1, 2, 3 or 4; 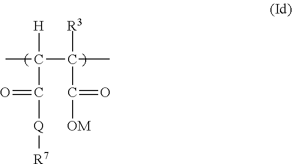
in which
R⁶ is H or an unbranched or branched C₁-C₄ alkyl group;
Q is NR⁷ or O;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂,
n is 1, 2, 3 or 4; and
each M independently is H or a cation equivalent.

10: The additive of claim 1, wherein the at least one water-soluble comb polymer comprises as units having a side chain with polyether moieties at least one structural unit of the general formulae (IIa), (IIb), (IIc) and/or (IId): 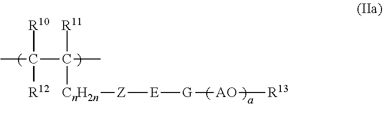
in which
R¹⁰, R¹¹ and R¹² independently of one another are H or an unbranched or branched C₁-C₄ alkyl group;
Z is O or S;
E is an unbranched or branched C₁-C₆ alkylene group, a cyclohexylene group, CH₂—C₆H₁₀, 1,2-phenylene, 1,3-phenylene or 1,4-phenylene;
G is O, NH or CO—NH; or E and G together are a chemical bond;
A is CₓH₂ₓ with x=2, 3, 4 or 5, or is CH₂CH(C₆H₅);
n is 0, 1, 2, 3, 4 or 5;
a is selected such that a number average molecular weight of the moiety -(AO)ₐ- is in a range of from 1000 to 5000;
R¹³ is H, an unbranched or branched C₁-C₄ alkyl group, CO—NH₂ and/or COCH₃; 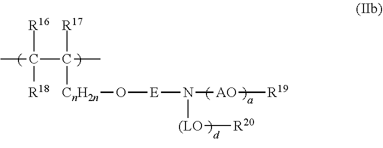
in which
R¹⁶, R¹⁷ and R¹⁸ independently of one another are H or an unbranched or branched C₁-C₄ alkyl group;
E is an unbranched or branched C₁-C₆ alkylene group, a cyclohexylene group, CH₂—C₆H₁₀, 1,2-phenylene, 1,3-phenylene, or 1,4-phenylene, or is a chemical bond;
A is CₓH₂ₓ with x=2, 3, 4 or 5, or is CH₂CH(C₆H₅);
n is 0, 1, 2, 3, 4 and/or 5;
L is CₓH₂ₓ with x=2, 3, 4 or 5, or is CH₂—CH(C₆H₅);
a and d are selected such that a number average molecular weight of the moieties -(AO)ₐ- and -(LO)_{d}— together are in a range of from 1000 to 5000;
R¹⁹ is H or an unbranched or branched C₁-C₄ alkyl group;
R²⁰ is H or an unbranched C₁-C₄ alkyl group; 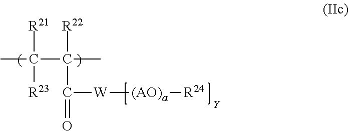
in which
R²¹, R²² and R²³ independently of one another are H or an unbranched or branched C₁-C₄ alkyl group;
W is O, NR²⁵, or is N;
Y is 1 if W═O or NR²⁵, and is 2 if W═N;
A is CₓH₂ₓ with x=2, 3, 4 or 5, or is CH₂CH(C₆H₅);
a is selected such that a number average molecular weight of the moiety -(AO)ₐ- or both moieties -(AO)ₐ- together are in a range of from 1000 to 5000;
R²⁴ is H or an unbranched or branched C₁-C₄ alkyl group; and
R²⁵ is H or an unbranched or branched C₁-C₄ alkyl group; 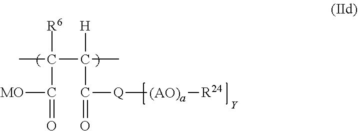
in which
R⁶ is H or an unbranched or branched C₁-C₄ alkyl group;
Q is NR¹⁰, N or O;
Y is 1 if W═O or NR¹⁰ and is 2 if W═N;
R¹⁰ is H or an unbranched or branched C₁-C₄ alkyl group; and
A is CₓH₂ₓ with x=2, 3, 4 or 5, or is CH₂C(C₆H₅)H;
R²⁴ is H or an unbranched or branched C₁-C₄ alkyl group;
M is H or a cation equivalent; and
a is selected such that a number average molecular weight of the moiety -(AO)ₐ- or both moieties -(AO)ₐ- together are in a range of from 1000 to 5000.

11: The additive of claim 1, wherein the side chains of the at least one water-soluble comb polymer have a molecular weight in a range of from 1000 to 4000.

12: The additive of claim 1, wherein a weight ratio of (a) to (b) is in a range of from 10:1 to 1:5.

13: The additive of claim 1, further comprising a calcium silicate hydrate.

14: A construction chemical composition, comprising the additive of claim 1 and an inorganic binder.

15: The construction chemical composition of claim 14, wherein the binder is an aluminate comprising cement.

16: The construction chemical composition of claim 14, wherein a weight ratio of the inorganic binder to the additive is in a range of from 10:1 to 10000:1.

17: A method for retarding the hardening of an inorganic binder-comprising building material formulation and/or for producing a building product, the method comprising adding the additive of claim 1 to the inorganic binder-comprising building material formulation or a construction chemical composition.
